(19) United States
(12) Patent Application Publication
(10) Pub. No.: US 2026/0261499 A1
(43) Pub. Date: Sep. 3, 2026

(54) INDUSTRIAL INTERNET OF THINGS (IIOT) SYSTEMS, METHODS, AND STORAGE MEDIA FOR ONLINE MAINTENANCE OF TRANSMITTERS

(71) Applicant: CHENGDU QINCHUAN IOT TECHNOLOGY CO., LTD., Chengdu (CN)

(72) Inventors: Zehua SHAO, Chengdu (CN); Yong LI, Chengdu (CN); Yunbai CHEN, Chengdu (CN); Chang SU, Chengdu (CN); Lei HE, Chengdu (CN)

(73) Assignee: CHENGDU QINCHUAN IOT TECHNOLOGY CO., LTD., Chengdu (CN)

(21) Appl. No.: 19/657,132

(22) Filed: Apr. 24, 2026

(30) Foreign Application Priority Data
Apr. 2, 2026 (CN) 202610425253.6

(51) Int. Cl. H04L 43/0817; H04L 43/0852; H04L 67/12

(52) U.S. Cl. CPC H04L 43/0817; H04L 43/0852; H04L 67/12

(57) ABSTRACT

An IIoT system, a method, and a storage medium for online maintenance of a transmitter are provided. The IIoT system comprises an IIoT management platform configured to: obtain monitoring data of the transmitter and operating condition data of a monitored device within a first predetermined time period; determine a cross-correlation coefficient; in response to the cross-correlation coefficient being less than a coefficient threshold, identify an abnormal fluctuation pattern corresponding to the monitoring data; determine a reliability indicator of the transmitter based on a data characteristic of the monitoring data; in response to the reliability indicator being less than a first reliability threshold, generate filter parameters, control the transmitter to adjust a filter window and/or a cut-off frequency; in response to the reliability indicator being less than or equal to a second reliability threshold, control the monitored device to shut down, trigger an alarm, and generate a manual maintenance work order.

### CROSS-REFERENCE TO RELATED APPLICATIONS

This application claims priority to Chinese Patent Application No. 202610425253.6, filed on April 2, 2026, the entire contents of which are hereby incorporated by reference.

### TECHNICAL FIELD

The present disclosure relates to the technical field of transmission maintenance, and in particular to an industrial Internet of Things (IIoT) system, a method, and a storage medium for online maintenance of a transmitter.

### BACKGROUND

In industrial sites (such as chemical plants and power plants), transmitters (such as pressure transmitters, temperature transmitters, vibration transmitters, or the like) are used to obtain device operating states (such as pipeline pressure and temperature) in real time, and to convert monitored physical quantities (such as pressure and temperature) into standard signals for remote transmission. However, industrial environments are typically subject to harsh conditions such as strong electromagnetic interference, high temperatures, and vibration, which may cause abnormal fluctuations in transmitter data. Conventional data analysis methods have difficulty accurately determining whether such abnormalities are caused by failures (e.g., a sudden increase in pressure due to pipeline blockage) of the monitored device itself, or by performance degradation or faults (e.g., zero drift, clock drift, or communication delay) of the transmitter.

At present, effective fault tracing means are lacking, and operation and maintenance personnel often rely on experience-based judgment or frequently replace transmitters, resulting in high maintenance costs and a high risk of misjudgment.

In view of the foregoing, it is desirable to provide an IIoT system, a method, and a storage medium for online maintenance of a transmitter, which can accurately distinguish real equipment abnormalities from transmitter faults in a high-noise environment, thereby improving the reliability and maintenance efficiency of industrial monitoring systems.

### SUMMARY

One or more embodiments of the present disclosure provide an industrial Internet of Things (IIoT) system for online maintenance of a transmitter. The IIoT system includes an IIoT management platform configured to implement a method for online maintenance of a transmitter.

One or more embodiments of the present disclosure provide a method for online maintenance of a transmitter. The method is implemented by an IIoT management platform of an IIoT system for online maintenance of a transmitter. The method includes: obtaining monitoring data of the transmitter and operating condition data of a monitored device within a first predetermined time period; determining a cross-correlation coefficient based on the monitoring data and the operating condition data, wherein the cross-correlation coefficient is configured to characterize a degree of correlation between fluctuation trends of the monitoring data and the operating condition data; in response to the cross-correlation coefficient being less than a coefficient threshold, identifying an abnormal fluctuation pattern corresponding to the monitoring data; determining a reliability indicator of the transmitter based on a data characteristic of the monitoring data, wherein the data characteristic includes at least one of a packet loss rate, a signal-to-noise ratio, and extreme value data; in response to the reliability indicator being less than a first reliability threshold, generating filter parameters based on the signal-to-noise ratio and a spectral distribution characteristic of the monitoring data, and controlling the transmitter to adjust a filter window and/or a cut-off frequency based on the filter parameters; and in response to the reliability indicator being less than or equal to a second reliability threshold, controlling the monitored device to shut down, triggering an alarm, and generating a manual maintenance work order, wherein the first reliability threshold is greater than the second reliability threshold.

One or more embodiments of the present disclosure provide a non-transitory computer-readable storage medium. The storage medium stores computer instructions that, when read by a computer, cause the computer to executes the method for online maintenance of a transmitter according to one or more of the embodiments of the present disclosure.

### BRIEF DESCRIPTION OF THE DRAWINGS

The present disclosure will be further elucidated by way of exemplary embodiments, which are described in detail with reference to the accompanying drawings. These embodiments are not limiting. In these embodiments, the same reference numerals denote the same structures, wherein:

FIG. 1 is an exemplary structural diagram of an industrial Internet of Things (IIoT) system for online maintenance of a transmitter according to some embodiments of the present disclosure;

FIG. 2 is a flowchart of an exemplary process of a method for online maintenance of a transmitter according to some embodiments of the present disclosure;

FIG. 3 is an exemplary schematic diagram of a prediction model according to some embodiments of the present disclosure; and

FIG. 4 is an exemplary schematic diagram illustrating adjustment of a trigger frequency according to some embodiments of the present disclosure.

### DETAILED DESCRIPTION

To more clearly illustrate the technical solutions of the embodiments of the present disclosure, the accompanying drawings to be used in the description of the embodiments will be briefly described below. Obviously, the accompanying drawings in the following description are only some examples or embodiments of the present disclosure, and that the present disclosure may be applied to other similar scenarios in accordance with these drawings without creative labor for those of ordinary skill in the art. Unless obviously acquired from the context or the context illustrates otherwise, the same numeral in the drawings refers to the same structure or operation.

It should be understood that “system,” “device,” “unit,” and/or “module” as used herein is a way to distinguish between different components, elements, parts, sections, or assemblies at different levels. However, these words may be replaced by other expressions if they accomplish the same purpose. The term “and/or”, as used herein, is merely a way of describing the associative relationship of an associated object, indicating that three relationships may exist, e.g., A and/or B, which may be represented as: A alone, both A and B, and B alone.

As indicated in the present disclosure and in the claims, the singular forms “a,” “an,” and “the” may be intended to include the plural forms as well, unless the context clearly indicates otherwise. In general, the terms “comprise,” “comprises,” and/or “comprising,” “include,” “includes,” and/or “including,” when used in this disclosure, specify the presence of stated features, integers, steps, operations, elements, and/or components, but do not preclude the presence or addition of one or more other features, integers, steps, operations, elements, components, and/or groups thereof.

Furthermore, if the description of the embodiments in the present disclosure involves descriptions such as "first" and "second," then these descriptions are for descriptive purposes only and are not to be construed as indicating or implying relative importance or implicitly specifying the quantity of the indicated technical features. Thus, features defined by "first" or "second" may explicitly or implicitly include at least one such feature.

Flowcharts are used in the present disclosure to illustrate the operations performed by the system according to some embodiments of the present disclosure. It should be understood that the operations described herein are not necessarily executed in a specific order. Instead, they may be executed in reverse order or simultaneously. Additionally, one or more other operations may be added to these processes, or one or more operations may be removed.

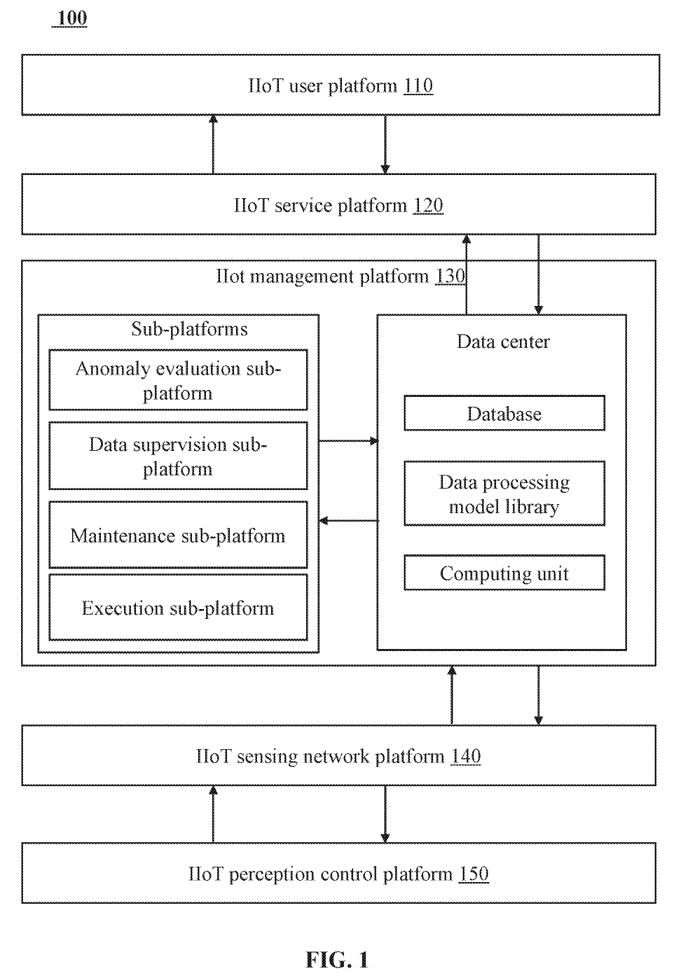

FIG. 1 is an exemplary structural diagram of an industrial Internet of Things (IIoT) system for online maintenance of a transmitter according to some embodiments of the present disclosure.

In some embodiments, as shown in FIG. 1, an IIoT system 100 for online maintenance of a transmitter (hereinafter referred to as the “system”) may include an IIoT management platform 130.

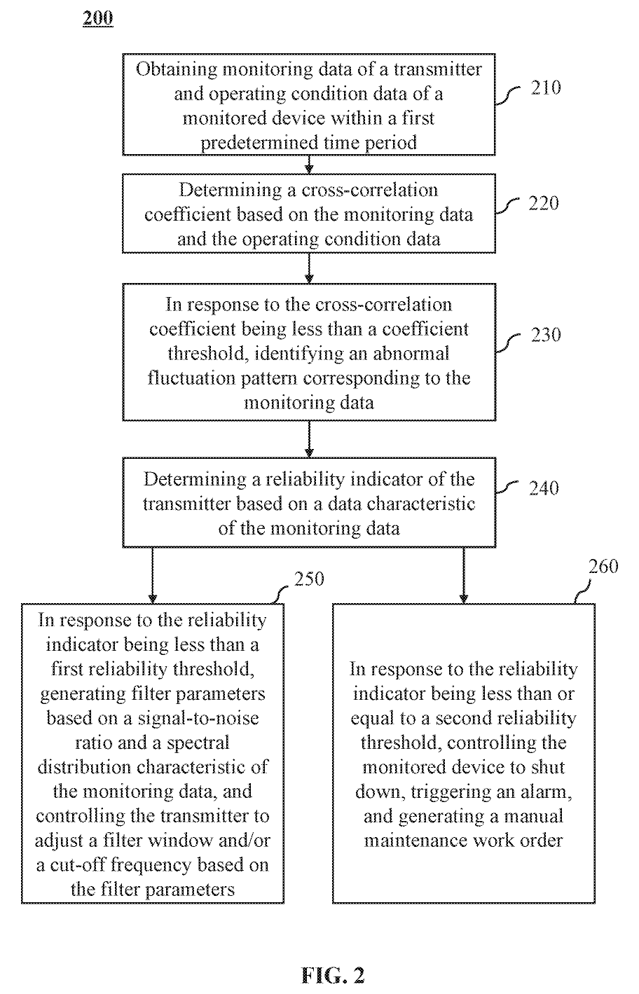

The IIoT management platform 130 refers to a digital monitoring and management platform for supervising a transmitter and a monitored device. Descriptions of the transmitter and the monitored device are provided with reference to FIG. 2 and the associated description thereof.

In some embodiments, the IIoT management platform 130 may be deployed on a processor and/or a server. The processor and/or server may process data and/or information obtained from other platforms. The processor and/or server may execute program instructions based on the data, information, and/or processing results, so as to perform one or more functions described in the present disclosure.

In some embodiments, the IIoT management platform 130 includes sub-platforms that communicate with each other and a data center. The sub-platforms may process data and/or information obtained from the data center.

In some embodiments, the sub-platforms include at least one of an anomaly evaluation sub-platform, a data supervision sub-platform, a maintenance sub-platform, and an execution sub-platform.

The anomaly evaluation sub-platform refers to a management platform for evaluating and preventing abnormal fluctuations in monitoring data and operating condition data.

The data supervision sub-platform refers to a platform configured to monitor, collect, and analyze monitoring data of the transmitter and operating condition data of the monitored device. Descriptions of the monitoring data of the transmitter and the operating condition data of the monitored device are provided with reference to FIG. 2 and the associated description thereof.

The maintenance sub-platform refers to a platform configured to identify an abnormal fluctuation, evaluate a reliability indicator, and generate a maintenance strategy. Descriptions of the reliability indicator are provided with reference to FIG. 2 and the associated description thereof.

The execution sub-platform refers to a platform configured to coordinate, schedule, and execute the maintenance strategy after abnormal fluctuations are identified.

In some embodiments, the data center includes a database, a data processing model library, and a computing unit.

The database is configured to collect, store, and manage a large amount of data related to transmitter supervision. For example, the database may include MySQL, PostgreSQL, InfluxDB, Prometheus, or the like.

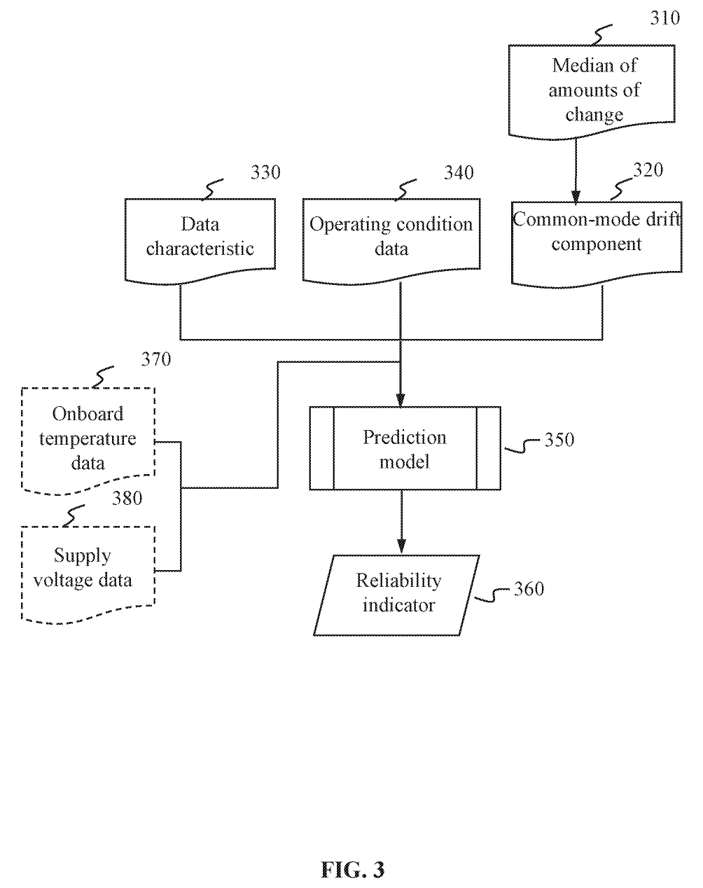

The data processing model library refers to a collection of data processing models used for data processing. In some embodiments, the data processing models may include prediction models or the like. Descriptions of the prediction model are provided with reference to FIG. 3 and the associated description thereof.

The computing unit refers to a functional module configured to execute arithmetic, logical, and other instruction operations. The computing unit may include, but is not limited to, a central processing unit (CPU), or the like.

In some embodiments, the system further includes an IIoT user platform 110, an IIoT service platform 120, an IIoT sensing network platform 140, and an IIoT perception and control platform 150.

The IIoT user platform refers to an interactive platform for management personnel. In some embodiments, the IIoT user platform may include at least one human–machine interaction device, such as a mobile phone, a computer, or the like. The management personnel may include staff of enterprises engaged in transmitter manufacturing, maintenance management, or the like.

The IIoT service platform refers to a platform configured to provide communication services. In some embodiments, the IIoT service platform may be configured as a server and may perform data interaction with the IIoT user platform and the IIoT management platform (e.g., the data center).

The IIoT sensing network platform refers to a platform configured to perform sensing communication of IIoT perception and control information, and is used to implement bidirectional communication transmission between the IIoT management platform (such as the data center) and the IIoT perception and control platform. For example, the IIoT sensing network platform may include communication devices, servers, and various gateway devices, or the like. The IIoT perception and control information may include monitoring data of the transmitter, operating condition data of the monitored device, a degree of correlation between fluctuation trends, or the like. Descriptions of the degree of correlation between fluctuation trends are provided with reference to FIG. 2 and the associated description thereof.

The IIoT perception and control platform refers to a platform configured to control IIoT perception and control information. In some embodiments, the IIoT perception and control platform may include perception and control of a plurality of monitored devices and transmitters. The IIoT perception and control platform may include device objects subject to perception and control and processing devices such as processors or servers.

In some embodiments of the present disclosure, by means of the IIoT system 100 for online maintenance of a transmitter, an information operation closed loop can be formed among the functional platforms, and coordinated and orderly operation can be achieved under unified management of the IIoT management platform, thereby realizing intelligent and information-based online maintenance of transmitters.

FIG. 2 is a flowchart of an exemplary process of a method for online maintenance of a transmitter according to some embodiments of the present disclosure. As shown in FIG. 2, process 200 includes steps 210 through 260, and process 200 is executed by the IIoT management platform.

In 210, obtaining monitoring data of the transmitter and operating condition data of a monitored device within a first predetermined time period. The first predetermined time period may be preset in advance based on manual experience.

The transmitter refers to a device that converts an original weak non-standard electrical signal (such as a millivolt-level thermoelectric potential) sensed by a sensing element (e.g., a piezoresistive diaphragm, a thermocouple, or the like) into a standard signal (e.g., a 4–20 mA analog current signal, a digital bus signal, or the like), and performs remote transmission.

In some embodiments, the transmitter includes a pressure transmitter, a temperature transmitter, or the like.

The monitoring data refers to data measured, collected, and uploaded by the transmitter with respect to the monitored device.

In some embodiments, the monitoring data includes a data timestamp, a frame sequence number, and monitored device data. The data timestamp is high-precision time information used to accurately identify an actual occurrence time at which a data point is acquired, for example, a count of seconds elapsed since 1970-01-01 00:00:00 UTC based on a Unix timestamp. The frame sequence number is an identifier used to uniquely identify and order data frames, for example, a 16-bit unsigned integer sequence starting from 0 and cyclically incrementing after reaching a maximum value (such as 65535), i.e., [0, 1, 2, …, 65535, 0, 1, …]. The monitored device data refers to data obtained after the transmitter measures and collects information of the monitored device, such as temperature, pressure, switch status, or the like of the monitored device (e.g., a pipeline).

In some embodiments, when the transmitter operates normally, the monitored device data is consistent with the operating condition data.

In some embodiments, the IIoT management platform may parse the monitoring data from data frames transmitted by the transmitter.

The monitored device refers to an industrial physical device directly measured by the transmitter, such as a pipeline, a motor, a valve, or the like.

The operating condition data refers to control or status signals that describe an operating state of the monitored device.

In some embodiments, the operating condition data includes discrete switch data and continuous control data.

The discrete switch data refers to state variables representing two or more explicit states of device (such as start/stop, on/off). For example, the discrete switch data may be 0 and 1, where 0 represents an off state and 1 represents an on state.

The continuous control data is used to regulate or control continuously varying control quantities of device operation, such as pipeline temperature, pipeline pressure, or the like.

In some embodiments, the IIoT management platform may obtain the operating condition data from the monitored device (for example, from a control system of the monitored device).

In 220, determining a cross-correlation coefficient based on the monitoring data and the operating condition data.

The cross-correlation coefficient is a parameter used to characterize a degree of correlation between fluctuation trends of the monitoring data and the operating condition data.

In some embodiments, the IIoT management platform may construct a measured data sequence from the monitored device data in the monitoring data within the first predetermined time period, designate the operating condition data within the first predetermined time period as an operating condition data sequence, and use a Pearson correlation coefficient between the measured data sequence and the operating condition data sequence as the cross-correlation coefficient.

In 230, in response to the cross-correlation coefficient being less than a coefficient threshold, identifying an abnormal fluctuation pattern corresponding to the monitoring data.

In some embodiments, the coefficient threshold is a statistical decision threshold used to determine whether a fluctuation trend of the transmitter monitoring data has a significant correlation with a fluctuation trend of the operating condition data of the monitored device.

It is known that there are two cases in which the cross-correlation coefficient is less than the coefficient threshold and in which the cross-correlation coefficient is not less than the coefficient threshold. In some embodiments, when the cross-correlation coefficient is less than the coefficient threshold, the IIoT management platform may determine that the fluctuation trend of the transmitter monitoring data is inconsistent with the fluctuation trend of the operating condition data of the monitored device, and in this case, the abnormal fluctuation pattern corresponding to the monitoring data needs to be identified. When the cross-correlation coefficient is not less than the coefficient threshold, the IIoT management platform may determine that the fluctuation trend of the monitoring data of the transmitter is consistent with the fluctuation trend of the operating condition data of the monitored device.

In some embodiments, the coefficient threshold is preset based on manual experience, for example, being preset to 0.7 or 0.8.

The abnormal fluctuation pattern may be characterized based on a feature waveform in which the monitoring data deviates from a normal variation pattern.

In some embodiments, the abnormal fluctuation pattern includes a step-type abnormality, a linear drift-type abnormality, or the like. The step-type abnormality refers to a waveform in which the monitoring data exhibits a substantially vertical rise or fall within a short period of time (for example, within 1 second). The linear drift-type abnormality refers to a waveform in which the monitoring data increases or decreases linearly over time.

In some embodiments, the IIoT management platform may plot a waveform by using time as a horizontal axis and the monitored device data in current monitoring data as a vertical axis. The plotted waveform is compared with waveforms of preset abnormal fluctuation patterns, and a preset abnormal fluctuation pattern corresponding to a waveform that is most similar to the plotted waveform is selected as the abnormal fluctuation pattern. The preset abnormal fluctuation patterns and corresponding waveforms may be preset in advance based on experience.

In 240, determining a reliability indicator of the transmitter based on a data characteristic of the monitoring data.

The data characteristic refers to one or more quantitative parameters describing integrity, authenticity, and quality states of the monitoring data during transmission and generation processes.

In some embodiments, the data characteristic includes at least one of a packet loss rate, a signal-to-noise ratio, and extreme value data of the monitoring data.

The packet loss rate is used to characterize transmission reliability of a communication link. In some embodiments, when receiving the monitoring data, the IIoT management platform may use a ratio of an actual count of data frames not received to an expected count of data frames to be received inferred based on frame sequence numbers as the packet loss rate, where the actual count of data frames not received is a difference between the expected count of data frames to be received and an actual count of data frames received.

The signal-to-noise ratio is a parameter used to quantify quality and purity of a signal. In some embodiments, the IIoT management platform may obtain the signal-to-noise ratio by performing spectral analysis on the measured data sequence.

The extreme value data refers to a maximum value and/or a minimum value in the measured data sequence that exceeds a normal measurement range. In some embodiments, the IIoT management platform may extract a maximum value and a minimum value from the measured data sequence, compare the extracted maximum value and minimum value with a preset safety upper limit and a preset safety lower limit of a transmitter measurement range, and designate a maximum value exceeding the preset safety upper limit or a minimum value lower than the preset safety lower limit as the extreme value data.

The reliability indicator is a quantitative value used to characterize a degree of credibility of current output data of the transmitter. That is to say, the more reliable the output data of the transmitter, the greater the reliability indicator.

In some embodiments, the more reliable the data output by the transmitter is, the more reliable an operating state of the transmitter is indicated to be, and the less likely abnormalities are to occur. Conversely, the less reliable the data output by the transmitter is, the less reliable the operating state of the transmitter is indicated to be, and the more likely abnormalities are to occur.

In some embodiments, the IIoT management platform may evaluate the data characteristic and designate an evaluation result as the reliability indicator. For example, the IIoT management platform may normalize the packet loss rate, the signal-to-noise ratio, and the extreme value data, weight the normalized results, and use a weighted result as the reliability indicator. In this case, weighting coefficients are all negative values, and the weighting coefficients may be preset based on manual experience.

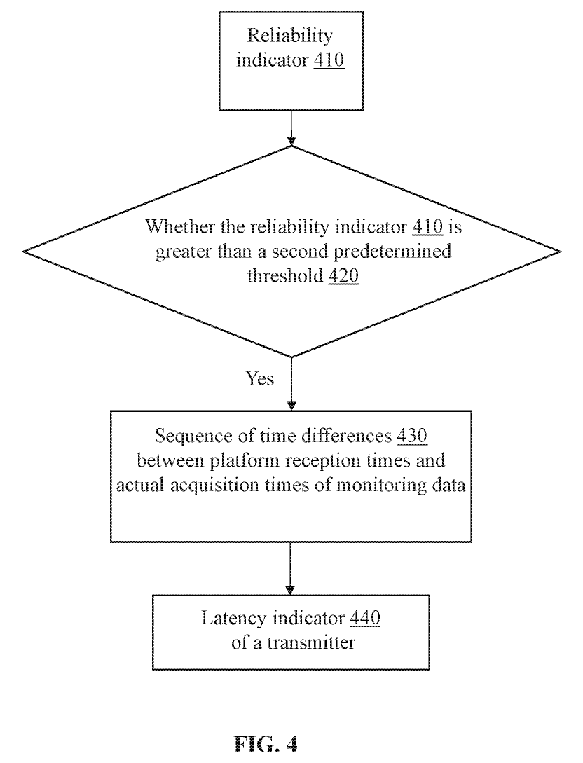

For more details regarding the reliability indicator, reference may be made to FIG. 4 and the associated description thereof.

It is known that there are two cases in which the reliability indicator is less than a first reliability threshold and in which the reliability indicator is not less than the first reliability threshold.

In 250, in response to the reliability indicator being less than the first reliability threshold, generating filter parameters based on the signal-to-noise ratio and a spectral distribution characteristic of the monitoring data, and controlling the transmitter to adjust a filter window and/or a cut-off frequency based on the filter parameters.

The first reliability threshold may be preset based on manual experience.

The spectral distribution characteristic refers to data used to characterize distribution of frequency components of the monitoring data. For example, the spectral distribution characteristic may include a distribution of a dominant frequency, harmonic components, and noise frequency bands.

In some embodiments, the IIoT management platform may perform a Fourier transform on the monitoring data to obtain the spectral distribution characteristic.

The filter parameters are a set of parameters used to configure a local filter of the transmitter.

In some embodiments, the filter parameters include filter window parameters and/or a cut-off frequency. The filter window parameters are a set of parameters defining a data range covered by each filtering operation (e.g., sampling performed by a filtering function) and movement rules thereof when processing a data sequence (e.g., the measured data sequence). The filter window parameters may include a window length, a sliding step size, and weighting coefficients. The window length refers to a countr of sampling points used when a filtering function such as a moving average filter performs sampling. The sliding step size refers to a step by which the window moves, which is typically 1 (that is, point-by-point sliding). The weighting coefficients refer to weights assigned to respective sampling points when a filtering function such as a moving average filter performs sampling. The cut-off frequency refers to a cut-off frequency of a filter, including a cut-off frequency of a low-pass filter used to remove high-frequency noise and a cut-off frequency of a high-pass filter used to remove direct-current drift.

In some embodiments, the IIoT management platform may extract frequency bands in which noise is concentrated in a spectrum by using a residual analysis algorithm based on the spectral distribution characteristic, and determine the filter parameters by querying a first preset table according to the frequency bands in which noise is concentrated and the signal-to-noise ratio. The first preset table records corresponding relationships among the frequency bands in which noise is concentrated, the signal-to-noise ratio, and the filter parameters. For example, the higher the frequency band in which noise is concentrated, the higher a cut-off frequency of a low-pass filter; and the higher the signal-to-noise ratio, the smaller a window length in the filter window parameters. The first preset table may be preset based on manual experience.

In some embodiments, the IIoT management platform may determine the filter window parameters in the filter parameters as the filter window of the transmitter, determine the cut-off frequency in the filter parameters as the cut-off frequency of the transmitter, and control the transmitter to adjust the filter window and/or the cut-off frequency based on the filter parameters.

It is known that there are two cases in which the reliability indicator is less than or equal to a second reliability threshold and in which the reliability indicator is greater than the second reliability threshold.

In 260, in response to the reliability indicator being less than or equal to the second reliability threshold, controlling the monitored device to shut down, triggering an alarm, and generating a manual maintenance work order.

The second reliability threshold is a parameter that is less than the first reliability threshold, and the second reliability threshold may be preset based on manual experience.

The manual maintenance work order is data used to guide workers to perform offline manual maintenance.

In some embodiments, the manual maintenance work order may include a monitored device identifier, a transmitter identifier, an occurrence time, or the like.

In some embodiments, when the reliability indicator is less than or equal to the second reliability threshold, the IIoT management platform may trigger audible and visual alarms in a control room or an on-site operation station, automatically create and populate the manual maintenance work order, and automatically dispatch the manual maintenance work order to a corresponding maintenance team or personnel according to a preset maintenance personnel schedule.

In some embodiments of the present disclosure, the IIoT management platform distinguishes real operating condition fluctuations from transmitter-specific abnormalities by using the cross-correlation coefficient, thereby fundamentally avoiding false alarms. Based on the reliability indicator, hierarchical intelligent handling is performed: when the reliability indicator is less than the first reliability threshold, it indicates that the transmitter may have a repairable minor abnormality, and online adaptive parameter adjustment is performed for the repairable minor abnormality; and when the reliability indicator is less than the second reliability threshold, it indicates that the transmitter may have a non-repairable severe fault, and for the non-repairable severe fault, device safety shutdown is coordinated and a manual maintenance work order is generated, thereby maximizing operational continuity while ensuring safety.

In some embodiments, the IIoT management platform may further control the transmitter to change a sampling frequency to a non-integer-multiple frequency value and perform resampling to obtain resampled data. In response to a waveform of the resampled data exhibiting frequency aliasing or a morphological mutation, an abnormal fluctuation of the monitoring data is determined to be a false signal caused by environmental noise; otherwise, the abnormal fluctuation of the monitoring data is determined to be a true signal caused by an actual operating condition fluctuation.

The sampling frequency refers to a frequency at which the transmitter obtains data from the monitored device.

The non-integer-multiple frequency value refers to a value at which a new sampling frequency does not have an integer-multiple relationship with an industrial power supply frequency or harmonic frequencies of the industrial power supply frequency. The harmonic frequencies of the industrial power supply frequency refer to integer-multiple frequency components of a fundamental frequency of the industrial power supply frequency (50 Hz or 60 Hz). The industrial power supply frequency or the harmonic frequencies thereof may be preset based on manual experience.

The non-integer-multiple frequency value may be selected based on manual experience. For example, in an environment in which the industrial power supply frequency is 50 Hz, frequencies such as 63 Hz or 47 Hz may be selected.

In some embodiments, the IIoT management platform controls the transmitter to change the sampling frequency to the non-integer-multiple frequency value, such that the transmitter reacquires data from the monitored device according to the changed sampling frequency, thereby performing resampling.

In some embodiments, the resampled data refers to monitoring data obtained after resampling.

In some embodiments, the waveform of the resampled data refers to a waveform plotted by using monitored device data in the resampled data as a vertical axis and sampling time as a horizontal axis.

The frequency aliasing refers to a phenomenon in which a high-frequency signal is incorrectly mapped to a low-frequency signal.

In some embodiments, the IIoT management platform may perform spectral analysis on the waveform of the resampled data, and determine that frequency aliasing has occurred when frequency components that do not exist in an original signal appear in a frequency band below a Nyquist frequency.

The morphological mutation refers to an unexpected drastic change in a basic shape, a period, or an amplitude of a waveform.

In some embodiments, the IIoT management platform may compare the waveform of the resampled data with the waveform of the monitoring data, and determine that a morphological mutation has occurred when a dominant frequency, an amplitude envelope, or a periodic characteristic changes significantly and discontinuously. For example, when a difference between a dominant frequency in the waveform of the resampled data and a dominant frequency in the waveform of the monitoring data is greater than a preset mutation threshold, the morphological mutation is determined to exist. The IIoT management platform may obtain the dominant frequency in the waveform of the resampled data (or the dominant frequency in the waveform of the monitoring data) by performing a Fourier transform on the waveform of the resampled data (or the waveform of the monitoring data).

The abnormal fluctuation of monitoring data refers to data in the monitoring data that does not conform to monitoring data normally collected by a transmitter.

In some embodiments, the presence of environmental noise or the occurrence of abnormal conditions in the monitored device may cause the transmitter to fail to normally collect monitoring data. When an abnormal condition occurs in the monitored device (such as a device failure), a corresponding abnormal fluctuation may be generated in the monitoring data. When environmental noise exists in the environment (such as electromagnetic interference), a corresponding abnormal fluctuation may also be generated in the monitoring data.

In some embodiments, when the abnormal fluctuation generated in the monitoring data is caused by environmental noise present in the environment, the abnormal fluctuation of the monitoring data is a false signal caused by environmental noise.

In some embodiments, when the abnormal fluctuation generated in the monitoring data is caused by an abnormal condition occurring in the monitored device, the abnormal fluctuation of the monitoring data is a true signal caused by an actual operating condition fluctuation.

It is known that there are two cases: one in which a waveform of resampled data exhibits frequency aliasing or a morphological mutation, and another in which the waveform of the resampled data does not exhibit frequency aliasing or a morphological mutation.

In some embodiments, if the waveform of the resampled data exhibits frequency aliasing or a morphological mutation, the IIoT (IIoT) management platform determines that the abnormal fluctuation of the monitoring data is a false signal caused by environmental noise; if the waveform of the resampled data does not exhibit frequency aliasing or a morphological mutation, the IIoT management platform determines that the abnormal fluctuation of the monitoring data is a true signal caused by an actual operating-condition fluctuation.

In some embodiments of the present disclosure, the IIoT management platform controls the transmitter to change the sampling frequency and perform resampling, and analyzes the resampled waveform to determine a cause of the abnormal fluctuation of the monitoring data, thereby accurately distinguishing environmental interference from an actual fault of the monitored device, effectively avoiding erroneous maintenance caused by external interference, and significantly enhancing the pertinence and effectiveness of maintenance.

FIG. 3 is an exemplary schematic diagram of a prediction model according to some embodiments of the present disclosure.

In some embodiments, the IIoT management platform is further configured to: determine a common-mode drift component 320 based on a median 310 of amounts of change in monitoring data of a plurality of transmitters; and determine a reliability indicator 360 based on a data characteristic 330 of the monitoring data, operating condition data 340 of a monitored device, and the common-mode drift component 320 through a prediction model 350, wherein the prediction model 350 is a machine learning model. Descriptions of the transmitter, the monitoring data, the monitored device, the data characteristic, and the operating condition data may be found in the related description of FIG. 2.

An amount of change in monitoring data refers to a degree of variation of the monitoring data. For example, the amount of change may be a percentage change of the monitoring data relative to a reference value within a time window. Descriptions of the time window may be found in the related description of FIG. 2. In some embodiments, the reference value may be preset based on experience. For example, the IIoT management platform may determine an average value of monitoring data collected by the transmitter under normal operating conditions, based on historical data, as the reference value. In some embodiments, the reference value may be determined based on a type of the transmitter. For example, when the transmitter is a temperature transmitter and the monitoring data is a temperature value, the reference value may be 25° C.

The monitoring data of a plurality of transmitters on a same monitoring device may be affected by environmental interference (such as overall temperature variation, ground potential drift, or an increase in electromagnetic noise floor), thereby generating readout drifts in a same direction.

A readout drift refers to a change in which readouts of a transmitter undergo drift with approximately the same magnitude.

The common-mode drift component refers to a quantified value used to characterize readout drifts of a plurality of transmitters.

In some embodiments, the IIoT management platform may obtain monitoring data of a plurality of transmitters on a same monitoring device within a current time window, calculate an amount of change in the monitoring data for each transmitter, and take a median of the amounts of change in the monitoring data of the plurality of transmitters as the common-mode drift component.

In some embodiments, the IIoT management platform may determine the reliability indicator 360 based on the data characteristic 330 of the monitoring data, the operating condition data 340 of the monitored device, and the common-mode drift component 320 through the prediction model 350.

In some embodiments, the prediction model is a machine learning model. For example, the prediction model may be any one of, or a combination of, a deep neural network (Deep Neural Network, DNN) or other customized model architectures.

As shown in the exemplary schematic diagram of the prediction model in FIG. 3, inputs of the prediction model 350 may include the data characteristic 330 of the monitoring data, the operating condition data 340 of the monitored device, and the common-mode drift component 320, and outputs may include the reliability indicator 360.

In some embodiments, the inputs of the prediction model further include onboard temperature data 370 and power supply voltage data 380 of a plurality of transmitters.

The onboard temperature data refers to temperature data of an internal circuit board of a transmitter or of key components thereof, such as a sensing head or an analog-to-digital converter (Analog-to-Digital Converter, ADC) chip.

In some embodiments, the IIoT management platform may obtain the onboard temperature data through a temperature sensor built into the temperature transmitter, and upload the onboard temperature data together with the monitoring data to a data processing model library.

The power supply voltage data refers to a voltage value that provides operating electrical power to internal circuits of the transmitter.

In some embodiments, the IIoT management platform may obtain the power supply voltage data through a voltage monitoring circuit built into a voltage transmitter, and upload the power supply voltage data together with the monitoring data to the data processing model library.

In some embodiments of the present disclosure, by using the onboard temperature data and the power supply voltage data as inputs of the prediction model, the prediction model is enabled to directly perceive an operating environment and operating state of the transmitter itself. This helps the prediction model distinguish signal distortion caused by internal temperature drift or power supply fluctuations of the transmitter from failures caused by substantive damage to sensing elements, thereby further refining granularity of fault root-cause diagnosis. By incorporating internal state features of the transmitter, the prediction model can better learn and adapt to normal operating patterns of the transmitter under different conditions (such as high temperature or unstable voltage), so that a more stable and accurate evaluation of the reliability indicator can still be made under complex conditions.

In some embodiments, the prediction model may be trained based on a large number of training samples with training labels. The IIoT management platform may input a plurality of training samples with training labels into an initial prediction model, construct a loss function based on the training labels and results output by the initial prediction model, and iteratively update parameters of the initial prediction model based on the loss function by using techniques such as gradient descent. When the loss function satisfies a preset training condition, a trained prediction model is obtained. The preset training condition may include convergence of the loss function, an iteration count reaching a threshold, or the like.

The training samples and the training labels may be obtained based on historical data. The training samples may include data characteristics of historical monitoring data, operating condition data of historical monitored devices, and historical common-mode drift components. The training labels may include reliability indicators corresponding to the training samples.

In some embodiments, the IIoT management platform may obtain, from historical data, data before transmission and data after transmission corresponding to the historical monitoring data, calculate a similarity between the monitoring data before transmission and the monitoring data after transmission, and designate the similarity as a training label. Transmission refers to a process in which the historical monitoring data is transmitted from a transmitter to the IIoT management platform. That is to say, the monitoring data before transmission is monitoring data stored in the transmitter, and the monitoring data after transmission is monitoring data received by the IIoT management platform.

In some embodiments of the present disclosure, by calculating the common-mode drift component, readout offsets of a plurality of transmitters caused by overall environmental changes (such as diurnal temperature variations) are quantified and stripped out, preventing such environmental effects from being misjudged as hardware failures of individual transmitters, thereby significantly reducing a batch false-alarm rate. By employing a machine-learning model that comprehensively considers multi-dimensional information such as the data characteristic, the operating condition data, and the common-mode drift component to predict the reliability indicator, complex nonlinear relationships can be captured more effectively than with traditional weighted calculations, enabling the reliability indicator to more closely reflect actual operating conditions and improving accuracy of fault classification and reliability evaluation.

FIG. 4 is an exemplary schematic diagram illustrating adjustment of a trigger frequency according to some embodiments of the present disclosure.

It is known that there are two cases in which a reliability indicator is greater than a second predetermined threshold and in which the reliability indicator is not greater than the second predetermined threshold. In some embodiments, in response to the reliability indicator 410 being greater than the second predetermined threshold 420, the IIoT management platform determines a latency indicator 440 of a transmitter based on a sequence of time differences 430 between platform reception times and actual acquisition times of monitoring data within a second predetermined time period. For more details regarding the reliability indicator 410, reference may be made to FIG. 2 and the related description thereof.

The second predetermined time period is a time window used for statistical analysis of network latency.

In some embodiments, the second predetermined time period includes a plurality of first predetermined time periods. The second predetermined time period may be preset based on empirical experience.

The platform reception time refers to a time at which the IIoT management platform receives the monitoring data.

In some embodiments, the IIoT management platform may automatically generate the platform reception time when the monitoring data is received.

The actual acquisition time refers to a time at which the transmitter obtains the monitoring data.

In some embodiments, the IIoT management platform may determine a timestamp in the monitoring data as the actual acquisition time.

The sequence of time differences refers to a sequence of time differences between a time at which the monitoring data is transmitted from the transmitter and a time at which the monitoring data is received by the IIoT management platform within the second predetermined time period.

In some embodiments, the IIoT management platform may determine, for each frame of monitoring data, a difference between the actual acquisition time and the platform reception time as a time difference corresponding to the frame, and sort time differences of a plurality of frames of the monitoring data received within the second predetermined time period according to the platform reception times of the monitoring data, to obtain the sequence of time differences.

The latency indicator is a parameter used to characterize and quantify network transmission latency and jitter associated with uploading transmitter data.

In some embodiments, the IIoT management platform may obtain a dimensionless value by normalizing a variance or a standard deviation of the sequence of time differences, and designate the dimensionless value as the latency indicator.

In some embodiments of the present disclosure, by using the sequence of time differences reflecting deviations between actual acquisition times and platform reception times, it is possible to directly and accurately measure a deviation of an internal clock of the transmitter relative to a system time base (a synchronization indicator), thereby facilitating subsequent clock calibration.

It is known that there are two cases in which the latency indicator is greater than an indicator threshold and in which the latency indicator is not greater than the indicator threshold. In some embodiments, in response to the latency indicator being greater than the indicator threshold, the IIoT management platform generates a frequency reduction parameter based on the latency indicator, and controls the transmitter to adjust a trigger frequency of a transmission timer based on the frequency reduction parameter, and extend a retransmission waiting time.

The indicator threshold is a threshold used to determine whether network latency has abnormally increased.

In some embodiments, the indicator threshold may be preset based on empirical experience.

The frequency reduction parameter refers to as parameter used to reduce a communication frequency of the transmitter.

In some embodiments, the frequency reduction parameter include the trigger frequency and the retransmission waiting time. The trigger frequency is a rate at which a data reporting action is periodically triggered, such as uploading monitoring data to the IIoT management platform.

In some embodiments, the IIoT management platform may first calculate a difference between the latency indicator and the indicator threshold, and determine the frequency reduction parameter according to a preset mapping relationship (for example, a preset linear function) based on the difference. The preset mapping relationship may be preset based on empirical experience. For example, the larger the difference is, the lower the trigger frequency is, and the longer the retransmission waiting time is.

In some embodiments, the IIoT management platform may adjust the trigger frequency of the transmission timer to the trigger frequency included in the frequency reduction parameter, and extend the retransmission waiting time to the retransmission waiting time included in the frequency reduction parameter.

In some embodiments of the present disclosure, by adjusting the trigger frequency of the transmission timer, the IIoT management platform reduces the count of network data packets per unit time, thereby reducing a probability of channel contention and helping to alleviate network congestion as a whole. By extending the retransmission waiting time, the IIoT management platform avoids network contention aggravated by immediate retransmissions, and increases a likelihood that the transmitter remains online under adverse network conditions.

In some embodiments, in response to the latency indicator being less than or equal to the indicator threshold, the IIoT management platform determines a synchronization indicator of the transmitter based on an occurrence time of an operational event of the monitored device and an acquisition time of the operational event by the transmitter within a third predetermined time period; in response to the synchronization indicator satisfying a preset condition, the IIoT management platform generates a clock calibration parameter based on the synchronization indicator, and controls the transmitter to set a sampling initial time based on the clock calibration parameter, and adjusts a frequency division coefficient of a sampling timer.

The third predetermined time period is a time window used to calculate clock synchronization deviation.

In some embodiments, the third predetermined time period includes a plurality of second predetermined time periods. The third predetermined time period may be preset based on empirical experience.

The operational event refers to an event in which an operating state of the monitored device undergoes a clear and identifiable change during operation, such as issuance of a valve opening/closing command, motor start/stop, pump start/stop, or switching of an operating mode of the monitored device. For example, the operational event may include a valve opening event.

The occurrence time of the operational event refers to a time at which the operational event occurs on the monitored device, for example, a time at which a valve opening command is issued.

In some embodiments, the IIoT management platform may obtain the operational event and the occurrence times of the operational event from a control system (e.g., a system that controls opening and closing of a valve).

The acquisition time of the operational event refers to a time at which the transmitter detects the occurrence of the operational event.

In some embodiments, the IIoT management platform may identify, from a measured data sequence, monitoring data corresponding to a characteristic change of an operational event (for example, a data frame corresponding to a point of abrupt slope change in a waveform plotted from the measured data sequence), and determine a timestamp of the monitoring data corresponding to the characteristic change of the operational event as the acquisition time of the operational event.

The IIoT management platform may determine the characteristic change of the operational event by querying a second preset table according to the operational event. The second preset table records a correspondence between operational events and characteristic changes of the operational events, and may be preset based on empirical experience. For example, when the monitored device monitored by the transmitter is a valve on a pipeline and the operational event is a valve closing command, the transmitter may monitor air flow velocity values at the valve as the measured data sequence, and take a sudden drop in the air flow velocity in the measured data sequence (for example, a reduction in air flow velocity exceeding 50%) as the characteristic change of the operational event.

The synchronization indicator is a parameter used to evaluate the accuracy of time synchronization of the transmitter.

In some embodiments, the IIoT management platform may calculate a time difference between an acquisition time at which the transmitter acquires an operational event and an occurrence time of the operational event, and take the time difference as a time difference corresponding to the operational event. An average value of time differences of a plurality of operational events within the third predetermined time period is taken as the synchronization indicator.

For more details about the synchronization indicator, reference may be made to the related descriptions hereinafter.

It is known that there are two cases in which the synchronization indicator satisfies the preset condition or does not satisfy the preset condition. In response to the synchronization indicator satisfying the preset condition, the processor may generate the clock calibration parameter based on the synchronization indicator. In some embodiments, the preset condition is used to determine whether the synchronization indicator is abnormal, and may be preset based on empirical experience.

The clock calibration parameter refers to one or more parameters used to correct an internal clock deviation of the transmitter.

In some embodiments, the clock calibration parameter may include a time offset and a frequency correction coefficient. The time offset is a parameter used to compensate for clock deviation, and the frequency correction coefficient is a parameter used to compensate for a long-term clock drift rate.

In some embodiments, the IIoT management platform may take a negative value of the synchronization indicator as the time offset. The IIoT management platform may designate ccurrence times of a plurality of operational events within the third predetermined time period as independent variables, and time differences of the plurality of operational event within the third predetermined time period are taken as dependent variables. The IIoT management platform may perform linear fitting using on the independent variables and dependent variables, and determine a slope of a fitted straight line as the frequency correction coefficient.

The sampling initial time refers to a time interval from a current sampling interrupt to occurrence of a next sampling interrupt.

In some embodiments, the IIoT management platform may determine the sampling initial time based on the time offset through a clock synchronization compensation algorithm, and set the determined sampling initial time as the sampling initial time of the transmitter.

The frequency division coefficient is a parameter used to reduce a counting frequency of a timer.

In some embodiments, the IIoT management platform may determine the frequency division coefficient based on the clock calibration parameter through an adaptive Proportional-Integral-Derivative (PID) frequency compensation algorithm, and set the determined frequency division coefficient as the frequency division coefficient of the sampling timer of the transmitter.

In some embodiments of the present disclosure, by comparing the occurrence time of the operational event of the monitored device with the acquisition time at which the transmitter acquires the operational event, the IIoT management platform can directly and accurately measure and determine the synchronization indicator, thereby providing a basis for online clock calibration. By setting the sampling initial time and adjusting the frequency division coefficient of the sampling timer, both phase and frequency of the clock can be calibrated simultaneously, ensuring that data acquisition of the transmitter remains synchronized with a system time base in a long-term and stable manner, and laying a foundation for multi-transmitter data fusion and precise event ordering.

In some embodiments, the IIoT management platform may determine a target monitoring transmitter based on a transmitter and a monitored device; obtain a monitoring data sequence of the transmitter and a monitoring data sequence of the target monitoring transmitter, and determine a cross-correlation function; in response to a cross-correlation peak value of the cross-correlation function being greater than a peak value threshold, determine a time shift amount corresponding to the cross-correlation peak value; determine a synchronization indicator of the transmitter based on the time shift amount; in response to the synchronization indicator satisfying a preset condition, generate a clock calibration parameter based on the synchronization indicator; control the transmitter to set a sampling initial time based on the clock calibration parameter, and adjust a frequency division coefficient of a sampling timer.

When the transmitter monitors an operational event of a monitored device, the target monitoring transmitter refers to another transmitter that is associated with monitoring the operational event of the monitored device.

In some embodiments, the IIoT management platform may take a transmitter that monitors the same monitored device as the transmitter as the target monitoring transmitter.

In some embodiments, the IIoT management platform may alternatively take a transmitter that is installed at a location close to the transmitter and is associated with the monitored device monitored by the transmitter as the target monitoring transmitter. For example, when the monitored device is a valve on a pipeline, the target monitoring transmitter may be a transmitter installed on a downstream pipeline of the valve monitored by the transmitter or on the valve itself.

The monitoring data sequence of the transmitter is a data sequence composed of monitoring data acquired by the transmitter within the third predetermined time period.

The monitoring data sequence of the target monitoring transmitter is a data sequence composed of monitoring data acquired by the target monitoring transmitter within the third predetermined time period.

For more details regarding the monitoring data, reference may be made to FIG. 2 and the related descriptions thereof.

The cross-correlation function is a function that describes a degree of similarity between two signals (e.g., the monitoring data sequence of the transmitter and the monitoring data sequence of the target monitoring transmitter). For example, the cross-correlation function describes the degree of similarity between the monitoring data sequence of the transmitter and the monitoring data sequence of the target monitoring transmitter under different time shift amounts. A time shift amount refers to a relative time delay between the two signals.

In some embodiments, the IIoT management platform may perform a cross-correlation operation on the monitoring data sequence of the transmitter and the monitoring data sequence of the target monitoring transmitter to obtain the cross-correlation function.

The cross-correlation peak value refers to a peak value of the cross-correlation function.

In some embodiments, the IIoT management platform may take a maximum value of the cross-correlation function as the cross-correlation peak value.

The peak threshold is a threshold used to determine whether the cross-correlation peak value has sufficient confidence. For example, when the cross-correlation peak value of the cross-correlation function is greater than the peak threshold, it may be determined that the cross-correlation peak value is not a meaningless peak value caused by noise.

In some embodiments, the peak threshold may be preset based on empirical experience.

In some embodiments, two cases are known: the cross-correlation peak value of the cross-correlation function being greater than the peak threshold, and the cross-correlation peak value of the cross-correlation function being not greater than the peak threshold. When the cross-correlation peak of the cross-correlation function is greater than the peak threshold, the IIoT management platform may take the time shift amount corresponding to the cross-correlation peak value as the synchronization indicator of the transmitter.

In some embodiments, the IIoT management platform may take the time shift amount corresponding to the cross-correlation peak value as the synchronization indicator of the transmitter.

In some embodiments, two cases are known: the synchronization indicator satisfying a preset condition, and the synchronization indicator not satisfying the preset condition. In response to the synchronization indicator satisfying the preset condition, a clock calibration parameter is generated based on the synchronization indicator; and the transmitter is controlled to set a sampling initial time and adjust a frequency division coefficient of a sampling timer based on the clock calibration parameter. For more details regarding the preset condition, the clock calibration parameter, setting the sampling initial time, and adjusting the frequency division coefficient of the sampling timer, reference may be made to the foregoing related descriptions.

In some embodiments of the present disclosure, the IIoT management platform uses the target monitoring transmitter as a reference benchmark and determines a temporal relationship between two transmitters by calculating the cross-correlation function, thereby further determining the synchronization indicator of the transmitter. In scenarios where timestamps of control system events are unreliable or difficult to obtain (for example, due to aging devices resulting in unreliable timestamps), an effective synchronization verification approach is provided. By setting the preak threshold, false matches caused by noise interference or unrelated process condition fluctuations are effectively filtered out, thereby improving the robustness and accuracy of synchronization determination.

In some embodiments, the IIoT management platform determines a transmission delay time based on a physical distance between the transmitter and the target monitoring transmitter, and determines the synchronization indicator of the transmitter based on the time shift amount and the transmission delay time.

The physical distance refers to a straight-line spatial distance between a location of the monitored device monitored by the transmitter and a location of the monitored device monitored by the target monitoring transmitter, or a distance along a medium propagation path. When the transmitter and the target monitoring transmitter monitor the same monitored device, the physical distance is 0.

In some embodiments, the IIoT management platform may obtain, from installation records of the transmitter and the target monitoring transmitter, the location of the monitored device monitored by the transmitter and the location of the monitored device monitored by the target monitoring transmitter, and further determine the physical distance based on the location of the monitored device monitored by the transmitter and the location of the monitored device monitored by the target monitoring transmitter.

In some embodiments, the IIoT management platform may obtain the physical distance from manually measured results.

The transmission delay time refers to a time required for a physical disturbance (such as a pressure wave or a temperature field change) to propagate from the location of the monitored device monitored by the transmitter to the location of the monitored device monitored by the target monitoring transmitter. When the transmitter and the target monitoring transmitter monitor the same monitored device, the transmission delay time is 0.

In some embodiments, the IIoT management platform may, based on the operating condition event, query a third preset table to determine a physical disturbance (e.g., a pressure wave or a temperature field change), query a fourth preset table based on the physical disturbance to determine a propagation rate corresponding to the physical disturbance, and take a ratio of the physical distance to the propagation rate as the transmission delay time. The third preset table records operational events and physical disturbances corresponding to the operational events, and the fourth preset table records physical disturbances and propagation rates corresponding to the physical disturbances. The third preset table and the fourth preset table may both be preset in advance based on empirical experience.

In some embodiments, the IIoT management platform may take a difference between the time shift amount and the transmission delay time as the synchronization indicator.

In some embodiments of the present disclosure, when the transmitter and the target monitoring transmitter do not monitor the same monitored device, by introducing the transmission delay time, the calculated synchronization indicator can purely reflect a clock offset, thereby significantly improving clock calibration accuracy and avoiding miscalibration.

The basic concepts have been described above. Obviously, for those skilled in the art, the detailed disclosure above is merely illustrative and does not constitute a limitation on the present disclosure. Although not explicitly stated, those skilled in the art may make various modifications, improvements, and corrections to the present disclosure. Such modifications, improvements, and corrections are suggested within the present disclosure and thus remain within the spirit and scope of the exemplary embodiments of the present disclosure.

Meanwhile, the present disclosure uses specific terms to describe the embodiments herein. Terms such as "one embodiment," "an embodiment," and/or "some embodiments" mean that a certain feature, structure, or characteristic related to at least one embodiment of the present disclosure. Therefore, it is emphasized and noted that the terms "an embodiment," "one embodiment," or "an alternative embodiment" mentioned two or more times at different locations in the present disclosure do not necessarily refer to the same embodiment. Furthermore, certain features, structures, or characteristics in one or more embodiments of the present disclosure may be appropriately combined.

Furthermore, unless explicitly stated in the claims, the order of processing elements and sequences, the use of numbers or letters, or the use of other names in the present disclosure is not intended to limit the order of the processes and methods described herein. Although the foregoing disclosure discusses some currently considered useful inventive embodiments through various examples, it should be understood that such details are for illustrative purposes only, and the appended claims are not limited to the disclosed embodiments. On the contrary, the claims are intended to cover all modifications and equivalent combinations that conform to the essence and scope of the embodiments of the present disclosure. For example, although the system components described above may be implemented via hardware devices, they may also be realized solely through software solutions, such as installing the described system on existing servers or mobile devices.

Similarly, it should be noted that to simplify the presentation of the present disclosure and thereby aid in understanding one or more inventive embodiments, in the descriptions of the embodiments of the present disclosure above, various features may sometimes be grouped into a single embodiment, figure, or description thereof. However, this disclosure manner does not imply that the subject matter of the present disclosure requires more features than those mentioned in the claims. In fact, the features of an embodiment are fewer than all the features of a single embodiment disclosed above.

In some embodiments, numbers describing quantities or attributes are used. It should be understood that such numbers used in the description of the embodiments may, in some examples, be modified by the terms "approximately," "about," or "substantially." Unless otherwise specified, "approximately," "about," or "substantially" indicates that the stated number allows for a variation of ±20%. Accordingly, in some embodiments, the numerical parameters used in the specification and claims are approximations, which may vary depending on the characteristics required by individual embodiments. In some embodiments, numerical parameters should consider the specified number of significant digits and adopt the method of general digit retention. Although the numerical ranges and parameters used to confirm their breadth in some embodiments of the present disclosure are approximations, in specific embodiments, such numerical values are set as accurately as possible within the feasible range.

For each patent, patent application, patent application publication, and other material, such as articles, books, specifications, publications, documents, etc., cited in the present disclosure, the entire content thereof is hereby incorporated by reference into the present disclosure. Excluded are application history documents that are inconsistent or conflict with the content of the present disclosure, and documents that limit the broadest scope of the claims of the present disclosure (whether currently or subsequently appended to the present disclosure). It should be noted that if the description, definition, and/or use of terms in the supplementary materials of the present disclosure are inconsistent or conflict with those in the present disclosure, the description, definition, and/or use of terms in the present disclosure shall prevail.

Finally, it should be understood that the embodiments described in the present disclosure are merely illustrative of the principles of the embodiments of the present disclosure.

Other variations may also fall within the scope of the present disclosure. Therefore, by way of example and not limitation, alternative configurations of the embodiments of the present disclosure may be considered consistent with the teachings of the present disclosure. Accordingly, the embodiments of the present disclosure are not limited to those explicitly introduced and described herein.

What is claimed is:

1. An industrial Internet of Things (IIoT) system for online maintenance of a transmitter, comprising an IIoT management platform, wherein the IIoT management platform is configured to:
obtain monitoring data of the transmitter and operating condition data of a monitored device within a first predetermined time period;
determine a cross-correlation coefficient based on the monitoring data and the operating condition data, wherein the cross-correlation coefficient is configured to characterize a degree of correlation between fluctuation trends of the monitoring data and the operating condition data;
in response to the cross-correlation coefficient being less than a coefficient threshold, identify an abnormal fluctuation pattern corresponding to the monitoring data;
determine a reliability indicator of the transmitter based on a data characteristic of the monitoring data, wherein the data characteristic includes at least one of a packet loss rate, a signal-to-noise ratio, and extreme value data;
in response to the reliability indicator being less than a first reliability threshold, generate filter parameters based on the signal-to-noise ratio and a spectral distribution characteristic of the monitoring data, and control the transmitter to adjust a filter window and/or a cut-off frequency based on the filter parameters; and
in response to the reliability indicator being less than or equal to a second reliability threshold, control the monitored device to shut down, trigger an alarm, and generate a manual maintenance work order, wherein the first reliability threshold is greater than the second reliability threshold.

2. The IIoT system of claim 1, wherein the IIoT management platform is further configured to:
obtain resampled data by controlling the transmitter to change a sampling frequency to a non-integer-multiple frequency value and to perform resampling; and
in response to a waveform of the resampled data exhibiting frequency aliasing or a morphological mutation, determine that an abnormal fluctuation of the monitoring data is a false signal caused by environmental noise; otherwise, determine that the abnormal fluctuation of the monitoring data is a true signal caused by an actual operating condition fluctuation.

3. The IIoT system of claim 1, wherein the IIoT management platform is further configured to:
determine a common-mode drift component based on a median of amount of change in monitoring data of a plurality of transmitters; and
determine the reliability indicator through a prediction model based on the data characteristic of the monitoring data, the operating condition data of the monitored device, and the common-mode drift component, wherein the prediction model is a machine learning model.

4. The IIoT system of claim 3, wherein an input of the prediction model includes onboard temperature data and supply voltage data of the plurality of transmitters.

5. The IIoT system of claim 1, wherein the IIoT management platform is further configured to:
in response to the reliability indicator being greater than a second predetermined threshold, determine a latency indicator of the transmitter based on a sequence of time differences between platform reception times and actual acquisition times of the monitoring data within a second predetermined time period, wherein the second predetermined time period includes a plurality of first predetermined time periods.

6. The IIoT system of claim 5, wherein the IIoT management platform is further configured to:
in response to the latency indicator being greater than an indicator threshold, generate a frequency reduction parameter based on the latency indicator; and
control the transmitter to adjust a trigger frequency of a transmission timer based on the frequency reduction parameter, and extend a retransmission waiting time.

7. The IIoT system of claim 5, wherein the IIoT management platform is further configured to:
in response to the latency indicator being less than or equal to an indicator threshold, determine a synchronization indicator of the transmitter based on an occurrence time of an operational event of the monitored device and an acquisition time of the operational event by the transmitter within a third predetermined time period, wherein the third predetermined time period includes a plurality of second predetermined time periods;
in response to the synchronization indicator satisfying a preset condition, generate a clock calibration parameter based on the synchronization indicator; and
control the transmitter to set a sampling initial time based on the clock calibration parameter, and adjust a frequency division coefficient of a sampling timer.

8. The IIoT system of claim 5, wherein the IIoT management platform is further configured to:
determine a target monitoring transmitter based on the transmitter and the monitored device;
obtain a monitoring data sequence of the transmitter and a monitoring data sequence of the target monitoring transmitter, and determine a cross-correlation function;
in response to a cross-correlation peak value of the cross-correlation function being greater than a peak value threshold, determine a time shift amount corresponding to the cross-correlation peak value;
determine a synchronization indicator of the transmitter based on the time shift amount;
in response to the synchronization indicator satisfying a preset condition, generate a clock calibration parameter based on the synchronization indicator; and
control the transmitter to set a sampling initial time based on the clock calibration parameter, and adjust a frequency division coefficient of a sampling timer.

9. The IIoT system of claim 8, wherein the IIoT management platform is further configured to:
determine a transmission delay time based on a physical distance between the transmitter and the target monitoring transmitter; and
determine the synchronization indicator of the transmitter based on the time shift amount and the transmission delay time.

10. A method for online maintenance of a transmitter, the method being executed by an industrial IoT (IIoT) management platform, and the method comprising:
obtaining monitoring data of the transmitter and operating condition data of a monitored device within a first predetermined time period;
determining a cross-correlation coefficient based on the monitoring data and the operating condition data, wherein the cross-correlation coefficient is configured to characterize a degree of correlation between fluctuation trends of the monitoring data and the operating condition data;
in response to the cross-correlation coefficient being less than a coefficient threshold, identifying an abnormal fluctuation pattern corresponding to the monitoring data;
determining a reliability indicator of the transmitter based on a data characteristic of the monitoring data, wherein the data characteristic includes at least one of a packet loss rate, a signal-to-noise ratio, and extreme value data;
in response to the reliability indicator being less than a first reliability threshold, generating filter parameters based on the signal-to-noise ratio and a spectral distribution characteristic of the monitoring data, and controlling the transmitter to adjust a filter window and/or a cut-off frequency based on the filter parameters; and
in response to the reliability indicator being less than or equal to a second reliability threshold, controlling the monitored device to shut down, triggering an alarm, and generating a manual maintenance work order, wherein the first reliability threshold is greater than the second reliability threshold.

11. The method of claim 10, further comprising:
obtaining resampled data by controlling the transmitter to change a sampling frequency to a non-integer-multiple frequency value and to perform resampling; and
in response to a waveform of the resampled data exhibiting frequency aliasing or a morphological mutation, determining that an abnormal fluctuation of the monitoring data is a false signal caused by environmental noise; otherwise, determining that the abnormal fluctuation of the monitoring data is a true signal caused by an actual operating condition fluctuation.

12. The method of claim 10, wherein the determining the reliability indicator of the transmitter based on the data characteristic of the monitoring data includes:
determining a common-mode drift component based on a median of amount of change in monitoring data of a plurality of transmitters; and
determining the reliability indicator through a prediction model based on the data characteristic of the monitoring data, the operating condition data of the monitored device, and the common-mode drift component, wherein the prediction model is a machine learning model.

13. The method of claim 12, wherein an input of the prediction model includes onboard temperature data and supply voltage data of the plurality of transmitters.

14. The method of claim 10, further comprising:
in response to the reliability indicator being greater than a second predetermined threshold, determining a latency indicator of the transmitter based on a sequence of time differences between platform reception times and actual acquisition times of the monitoring data within a second predetermined time period, wherein the second predetermined time period includes a plurality of first predetermined time periods.

15. The method of claim 14, further comprising:
in response to the latency indicator being greater than an indicator threshold, generating a frequency reduction parameter based on the latency indicator; and
controlling the transmitter to adjust a trigger frequency of a transmission timer based on the frequency reduction parameter, and extending a retransmission waiting time.

16. The method of claim 14, further comprising:
in response to the latency indicator being less than or equal to an indicator threshold, determining a synchronization indicator of the transmitter based on an occurrence time of an operational event of the monitored device and an acquisition time of the transmitter for the operational event within a third predetermined time period, wherein the third predetermined time period comprises a plurality of second predetermined time periods;
in response to the synchronization indicator satisfying a preset condition, generating a clock calibration parameter based on the synchronization indicator; and
controlling the transmitter to set a sampling initial time based on the clock calibration parameter, and adjusting a frequency division coefficient of a sampling timer.

17. The method of claim 14, further comprising:
determining a target monitoring transmitter based on the transmitter and the monitored device;
determining a cross-correlation function by obtaining a monitoring data sequence of the transmitter and a monitoring data sequence of the target monitoring transmitter;
in response to a cross-correlation peak value of the cross-correlation function being greater than a peak value threshold, determining a time shift amount corresponding to the cross-correlation peak value;
determining the synchronization indicator of the transmitter based on the time shift amount;
in response to the synchronization indicator satisfying a preset condition, generating a clock calibration parameter based on the synchronization indicator; and
controlling the transmitter to set a sampling initial time based on the clock calibration parameter, and adjusting a frequency division coefficient of a sampling timer.

18. The method of claim 17, wherein determining the synchronization indicator of the transmitter based on the time shift amount includes:
determining a transmission delay time based on a physical distance between the transmitter and the target monitoring transmitter; and
determining the synchronization indicator of the transmitter based on the time shift amount and the transmission delay time.

19. A non-transitory computer-readable storage medium storing computer instructions, wherein, when reading the computer instructions in the storage medium, a computer executes a method for online maintenance of a transmitter, and the method comprising:
obtaining monitoring data of the transmitter and operating condition data of a monitored device within a first predetermined time period;
determining a cross-correlation coefficient based on the monitoring data and the operating condition data, wherein the cross-correlation coefficient is configured to characterize a degree of correlation between fluctuation trends of the monitoring data and the operating condition data;
in response to the cross-correlation coefficient being less than a coefficient threshold, identifying an abnormal fluctuation pattern corresponding to the monitoring data;
determining a reliability indicator of the transmitter based on a data characteristic of the monitoring data, wherein the data characteristic includes at least one of a packet loss rate, a signal-to-noise ratio, and extreme value data;
in response to the reliability indicator being less than a first reliability threshold, generating filter parameters based on the signal-to-noise ratio and a spectral distribution characteristic of the monitoring data, and controlling the transmitter to adjust a filter window and/or a cut-off frequency based on the filter parameters; and
in response to the reliability indicator being less than or equal to a second reliability threshold, controlling the monitored device to shut down, triggering an alarm, and generating a manual maintenance work order, wherein the first reliability threshold is greater than the second reliability threshold.
